(19) United States
(12) Patent Application Publication
(10) Pub. No.: US 2026/0101847 A1
(43) Pub. Date: Apr. 16, 2026

(54) FOLDABLE HARVEST ATTACHMENT FOR ROW-INDEPENDENT MAIZE HARVESTING

(71) Applicant: Maschinenfabrik Bernard Krone GmbH & Co. KG, Spelle (DE)

(72) Inventors: MARTIN BOLSMANN, Andervenne (DE); TOBIAS OSKAMP, Ochtrup (DE); FRANK AHLMER, Westerkappeln (DE); MARKUS ESTER, Beesten (DE); STEVEN BÜCHTER, Recke (DE); Hannes Mählmann-Dunker, Neuekirchen (DE)

(21) Appl. No.: 19/353,701

(22) Filed: Oct. 9, 2025

(30) Foreign Application Priority Data
Oct. 9, 2024 (DE) 102024129135.4

(51) Int. Cl. A01D 41/14; A01D 45/02

(52) U.S. Cl. CPC A01D 41/144; A01D 45/021

(57) ABSTRACT

The present invention relates to a header (10) for row-independent harvesting of corn using a forage harvester (80). The header (10) comprises at least three header segments (1, 2, 3, 4), including a first central header segment (1). Each of the header segments (1, 2, 3, 4) includes a conveying element (18) that rotates during operation to convey corn plants in a segment-specific conveying direction (SR1, SR2, SR3,SR4) toward a feed area (14). The header (10) further comprises a transfer mechanism (20) for shifting the header (10) from a working position (I) into a transport position (VI). In the working position (I), the header segments (1, 2, 3, 4) are arranged side-by-side in a transverse direction (QR) such that their segment-specific conveying directions (SR1, SR2, SR3, SR4) are aligned parallel to a ground plane (AE) and oriented toward the feed area (14). In the transport position (VI), at least one of the header segments (1, 2, 3, 4) is arranged such that its segment-specific conveying direction (SR1, SR2, SR3, SR4) is angled relative to the ground plane (AE). According to the invention, the transfer mechanism (20) is configured such that the segment-specific conveying direction (SR1) of the first header segment (1) is angled relative to the ground plane (AE) in the transport position (VI) of the header (10).

The invention relates to a header for row-independent harvesting of corn. The header includes a frame structure designed for coupling with a forage harvester and at least three header segments. Each of the at least three header segments features at least one cutting element and at least one conveying element. The cutting element rotates during operation and serves to cut corn plants. The conveying element also rotates during operation and serves to transport the corn plants in a segment-specific conveying direction of the respective header segment. The header includes a transfer mechanism for shifting the header from a working position into a transport position. In the working position, the header segments connect to each other in a transverse direction perpendicular to the direction of travel in such a way that their segment conveying directions are parallel to a contact plane and aligned with a feed area of the header. The feed area is cut by a longitudinal centre plane perpendicular to the transverse direction. The corn plants are to be drawn in from the feed area by the forage harvester at least partially against the direction of travel. In the transport position, at least one of the front-end segments is arranged in such a way that its segment conveyor direction is angled relative to the contact plane. The at least three front-end segments comprise at least a first front-end segment which extends in or through the feed area in the working position.

Such headers are known. Their performance is evaluated based on the area of land to be harvested or the mass of corn to be harvested per unit of time. To ensure that as much corn as possible is harvested at its optimal stage of ripeness, high performance is advantageous. Performance can be increased, for example, by extending the header segments of the header arranged in the working position across the transverse direction—that is, by increasing the working width. In addition to achieving the highest possible performance, the header is also intended to have the smallest possible extension in the transverse direction when in the transport position—that is, a minimal transport width—so that it can be transported on public roads, ideally without requiring special permits and without being dismounted from the forage harvester. To date, for example, there are no known headers for row-independent corn harvesting that exceed a working width of 9 metres while maintaining a transport width of no more than 3 metres.

In contrast to the generic header, a first known header comprises only two header segments, each of which, in the working position of the header, extends from one side into the feed area. In the transport position, each of these segments is arranged such that its segment-specific conveying direction is angled relative to the ground plane. A second known header comprises three header segments, of which only a first header segment, in the working position of the header, extends into the feed area from both sides. In this case, the two additional header segments are arranged in the transport position such that their segment-specific conveying directions, like that of the first header segment, are aligned parallel to the ground level. Both the first and second known headers use conveyor chains as conveying elements, which, during operation, circulate around two rotating deflection elements within each respective header segment. A third known header comprises five header segments, of which only a first header segment, again extending into the feed area from both sides in the working position, is arranged such that the four additional header segments, in the transport position, have their segment-specific conveying directions angled relative to the ground level.

The objective of the present invention is to provide a generic-type header for row-independent harvesting of corn that achieves an improved ratio between working width and transport width with the highest possible reliability. Another objective of the invention is to provide an improved transfer mechanism for shifting the header between positions, as well as to offer a forage harvester system that includes the header.

For this purpose, a header for row-independent harvesting of corn is created, comprising
a frame structure designed for coupling with a forage harvester; at least three header segments, each featuring at least one rotating cutting element for cutting corn plants and at least one rotating conveying element for transporting the corn plants in a segment-specific conveying direction, and
a transfer mechanism for shifting the header from a working position—where the header segments are arranged side-by-side in a transverse direction perpendicular to the direction of travel, such that their conveying directions are parallel to the ground plane and oriented toward a feed area intersected by a longitudinal centreline perpendicular to the transverse direction, from which the corn plants are drawn in by the forage harvester at least partially against the direction of travel—to a transport position, in which at least one of the header segments is arranged such that its conveying direction is angled relative to the ground plane,
   wherein the at least three header segments include at least one first header segment that, in the working position, extends into or through the feed area.

According to the invention, the objective is achieved by designing the transfer mechanism such that the conveying direction of the first header segment is angled relative to the ground plane in the transport position. The inventive header thus comprises at least three header segments, of which at least one—extending into or through the feed area in the working position and, in particular, positioned between at least two other header segments—is at least partially pivoted during the transfer from the working position to the transport position around an imaginary pivot axis that is arranged non-orthogonally to the ground plane. This enables a particularly space-saving arrangement of the header segments in the transport position of the harvesting front-end.

Headers for row-independent harvesting of corn are characterized by their ability to operate regardless of whether the direction of travel aligns with the orientation of the rows of corn plants to be harvested. Additionally, such headers can be used independently of the spacing between the rows. Only through the segmentation of the header into segments that are movable relative to one another—allowing the header to be shifted from the working position into the transport position—is it possible to achieve a working width that exceeds the transport width permitted on public roads. Each header segment is defined by its cutting and conveying functions. During operation, both the cutting elements and the conveying elements of the header segments rotate around axes that are angled relative to the ground level.

Each header segment has a structurally defined segment conveying direction, which is particularly aligned tangentially to at least one axis around which the respective conveying element rotates during operation. This segment conveying direction is preferably fixed in relation to a segment frame of the respective header segment, which, in the working position, is especially fixed relative to the frame structure. This means that any change in the orientation or alignment of a header segment necessarily results in a corresponding change in the orientation or alignment of its segment conveying direction. The segment conveying direction globally describes the direction in which corn plants are conveyed by the respective header segment during operation. Specifically, it refers to the direction in which a corn plant, taken up at one end of the header segment by at least one conveying element, is moved and transferred at the other end. This applies regardless of whether one or more conveying elements within the header segment locally or partially convey the corn plants in directions that deviate from the segment conveying direction—for example, in cases where multiple conveying elements rotate around adjacent axes. The segment conveying direction remains a defining property of the front-end segments even when, such as in the transport position, they are not practically or effectively used for conveying.

The working width and transport width of the header are each measured in the transverse direction. The transverse direction, like the direction of travel, is aligned parallel to the ground plane. The ground plane ideally represents the surface of the soil from which the corn plants to be cut and conveyed grow. In particular, the header and/or the forage harvester contacts the ground plane during operation, preferably via a wheel assembly. In the working position, the header segments are preferably arranged such that their segment conveying directions are parallel to the ground plane, and more preferably parallel to the transverse direction.

The feed area is a fixed part of the header. It is typically located centrally—especially between the innermost conveying elements—and/or near or within the frame structure. The feed area is defined such that, during proper use of the header, the cut and conveyed corn plants are drawn in from this area by an intake mechanism of the forage harvester. The extension of the first header segment into the feed area means that the corn plants are transferred from at least one conveying element of the first header segment to the intake mechanism during operation.

In the working position, the header segments are at least partially arranged side-by-side in the transverse direction such that one header segment transfers corn plants to an adjacent segment for further conveying. This arrangement does not exclude the possibility that the segment conveying directions of these header segments may be offset or angled relative to one another. In a first preferred embodiment of the header, the first header segment extends into the feed area from one side only. This means, in particular, that the longitudinal centreline does not intersect the first header segment. In a second preferred embodiment, the first header segment extends through the feed area and is intersected centrally by the longitudinal centreline. Preferably, the header is at least substantially mirror-symmetrical with respect to the longitudinal centreline. Auxiliary components or elements for power transmission from the forage harvester to the header are not considered in this symmetry. In the second preferred embodiment, the first header segment is especially mirror-symmetrical to the longitudinal centreline and preferably has two opposing segment conveying directions. The longitudinal centreline extends perpendicular to the ground plane and parallel to the direction of travel.

Preferably, the transfer mechanism is designed such that the segment conveying direction of the first header segment is angled at least 60° relative to the ground plane in the transport position. More preferably, the segment conveying direction of the first header segment in the transport position is aligned parallel to the longitudinal centreline. This alignment allows the first header segment to extend primarily vertically in the transport position, thereby freeing up space beside it for the other header segments, extending down to the ground plane.

It is preferred that the transfer mechanism is designed such that the segment conveying direction of the first header segment in the transport position is oriented away from the ground plane. This applies especially when the first header segment is designed to extend into the feed area from one side only and has exactly one segment conveying direction. In this case, the transfer of the header includes lifting the end of the first header segment that is positioned in the feed area during the working position relative to the opposite, particularly outer, end of the segment. In the transport position, the first header segment is preferably not intersected by the longitudinal centreline. This arrangement enables a novel, space-saving folding of the header segments in the transport position. Preferably, the harvesting header has at least four, in particular exactly four, header segments.

Preferably, the transfer mechanism is configured such that the segment conveying directions of all header segments, in the transport position, are angled relative to the ground plane-preferably by at least 60°. Specifically, in the transport position, the segment conveying directions of all header segments are aligned parallel to the longitudinal centreline. In this configuration, the segment conveying directions of adjacent header segments are preferably oriented in opposite directions. This allows the header segments, when arranged in a substantially vertical orientation, to interlock in such a way that they occupy minimal space in the transverse direction.

Each header segment preferably includes at least one, and more specifically exactly one, conveying element designed as a conveyor chain. This conveying element circulates during operation around at least two deflection elements, which are preferably rotatably mounted on the segment frame. Additional conveying elements are preferably not present in the header segments. The conveyor chains preferably feature outwardly protruding conveyor teeth designed to grip and carry the cut corn plants.

The deflection elements rotate during operation around axes that are spaced apart and angled relative to the ground plane, with at least one deflection element per header segment being driven. The transverse span of the conveying elements preferably corresponds at least substantially to the transverse span of the header segment that contains the respective conveying element. The cutting elements of the header segments are particularly preferably designed as rotating cutting chains, which further enhances reliability and reduces the spatial footprint of the header segments.

Preferably, a conveying element of the first header segment is configured to convey corn plants in the segment conveying direction of the first header segment along a first segment conveying path. Likewise, a conveying element of the second header segment is preferably configured to convey corn plants in the segment conveying direction of the second header segment along a second segment conveying path. In the working position of the header, the second header segment is preferably positioned adjacent to the side of the first header segment that faces away from the longitudinal centreline. The second segment conveying path is preferably longer than the first, which enables particularly wide working widths. In the transport position, this configuration allows the forage harvester operator to see between the outer header segments.

The first header segment is preferably pivotably mounted on a transfer element around a transfer segment pivot axis. The transfer element is itself preferably pivotable around a transfer frame pivot axis relative to or on the frame structure. Alternatively or additionally, the second header segment is preferably pivotably mounted on the first header segment around an intermediate segment pivot axis. For each pivot axis, the header preferably includes at least one actuator, particularly designed as a hydraulic cylinder, to perform the respective pivoting movements.

The aforementioned axes are preferably arranged as follows. In a side view of the lowered header in its working position, where the viewing direction aligns with the transverse direction, the transfer segment pivot axis, the transfer frame pivot axis, and/or the intermediate segment pivot axis are preferably angled relative to the ground plane—particularly by less than 25°. The intersection points of these axes with the ground plane are preferably located behind the header relative to the direction of travel. In a front view of the harvesting header lowered for use in its working position, where the viewing direction is opposite to the direction of travel, the transfer segment pivot axis and/or the transfer frame pivot axis are preferably angled relative to the longitudinal centreline—particularly by more than 25°. The ground plane is preferably situated between the header and the intersection point of the transfer segment pivot axis and/or the transfer frame pivot axis with the longitudinal centreline. In a top view of the harvesting header lowered for use in its working position, where the viewing direction is perpendicular to the ground plane, the transfer segment pivot axis, the transfer frame pivot axis, and/or the intermediate segment pivot axis are preferably angled relative to the longitudinal centreline—particularly by less than 25°. The intersection points of the transfer segment pivot axis and/or the transfer frame pivot axis with the longitudinal centreline are preferably located behind the header relative to the direction of travel. The intersection point of the intermediate segment pivot axis with the longitudinal centreline is preferably located in front of the header relative to the direction of travel.

The inventive configuration of the header allows for an increase in the working width of row-independent corn headers beyond currently known limits, without restricting transport on public roads. Specifically, working widths exceeding 9 metres are possible, including 14-row and 16-row corn headers with a row spacing of 0.75 metres, while maintaining a transport width of no more than 3 metres. This enables road transport of the header without requiring special permits.

The objective is further achieved by a transfer method for shifting the header from the working position into the transport position and/or from the transport position back into the working position. The following describes in detail the transfer method for moving the header from the working position into the transport position. The transfer method for returning the header from the transport position to the working position preferably occurs in reverse chronological order, such that the features described below are to be understood as temporally reversed when characterizing the transfer from the transport position into the working position.

The transfer method includes a first pivoting of the second header segment relative to the first header segment, particularly around the intermediate segment pivot axis. It also includes a further pivoting of the first header segment relative to the frame structure. This further pivoting occurs in a first pivot direction, which may be clock-wise or counterclockwise depending on the viewing perspective. The transfer method is characterized by the fact that the first pivoting begins before the further pivoting begins.

In the working position, the first header segment connects to the second header segment and is at least partially arranged between the second header segment and the longitudinal centreline. In practice, the second header segment is first pivoted upward at least partially before the first header segment is pivoted. This reduces the risk of collision between the header and the ground or with elements located laterally around the header. Preferably, the first pivoting occurs through approximately 180°, and/or the second pivoting through approximately 90°. The second pivoting may include a complex movement, such as one with a translational component, but must in any case involve rotation in the mechanical or physical sense.

Preferably, the first pivoting takes place in a second pivoting direction that is opposite to the first pivoting direction. That is, the first pivoting occurs counterclockwise or clockwise. These opposing pivot directions explicitly refer to different geometric pivot axes. This configuration of the transfer method ensures, in particular, that the segment conveying direction of the first header segment in the transport position is oriented away from the ground plane.

Preferably, the transfer process proceeds such that a second pivoting of the first header segment relative to the frame structure occurs in the second pivot direction. This second pivoting preferably begins and/or ends before the further pivoting. During the transfer process, the first header segment is thus pivoted sequentially in two different directions. This allows the first header segment to be released from a particularly secure locking mechanism before being moved into its compact transport position. The further pivoting preferably begins when the second pivoting ends, making the transfer method particularly time-efficient.

Preferably, the second pivoting includes pivoting the transfer element relative to the frame structure around the transfer frame pivot axis. More preferably, the second pivoting consists exclusively of pivoting the transfer element relative to the frame structure around the transfer frame pivot axis. This simplifies execution of the transfer method without limiting its functional scope.

The second pivoting preferably begins during the first pivoting. More preferably, it also ends during the first pivoting. This saves time, as the pivoting of the two header segments relative to each other can occur largely independently of the pivoting of the first header segment relative to the frame structure, at least in the early stages.

Preferably, the first pivoting ends before or during the end of the further pivoting. This means, in particular, that the second header segment is fully folded onto the first header segment before the first header segment reaches its final position relative to the frame structure. This helps prevent collisions between the outer header segments, especially in cases where their segment conveying paths are longer than that of the first header segment.

The further pivoting preferably includes a third pivoting of the first header segment relative to the transfer element around the transfer segment pivot axis and/or a fourth pivoting of the transfer element relative to the frame structure around the transfer frame pivot axis. In particular, the further pivoting consists exclusively of the third and fourth pivoting movements. By using the transfer element and thus two pivot axes for the further pivoting, a particularly wide lateral displacement of the first header segment can be achieved while maintaining a robust mounting to the frame structure.

Preferably, the third pivoting begins—and more preferably ends—before or during the start of the fourth pivoting. Ideally, the third and fourth pivoting movements follow one another directly. This saves time and increases the reliability of the transfer method by avoiding simultaneous pivoting around both the transfer segment pivot axis and the transfer frame pivot axis.

Preferably, the second, third, and/or fourth pivoting movements begin—and more preferably end—before the first pivoting ends. Ideally, the second and third pivoting movements end before the first pivoting, while the fourth pivoting ends afterward. This allows the various functions of the transfer mechanism to be executed in parallel without compromising reliability. The transfer method does not include any movements of the header segments relative to the frame structure beyond the first through fourth pivoting movements.

The objective is further achieved by a forage harvester system. The forage harvester system includes a forage harvester equipped with a chassis comprising multiple drive elements in contact with the ground plane, an intake mechanism, a chopping unit, and a discharge chute. The system also includes the header described above, which is coupled to the forage harvester via the frame structure such that, during operation, the intake mechanism draws in corn plants from the feed area at least partially against the direction of travel. The forage harvester system is specifically designed to carry out the transfer method described above.

Further details and advantages of the invention can be derived from the schematically illustrated and subsequently described figures, which show:

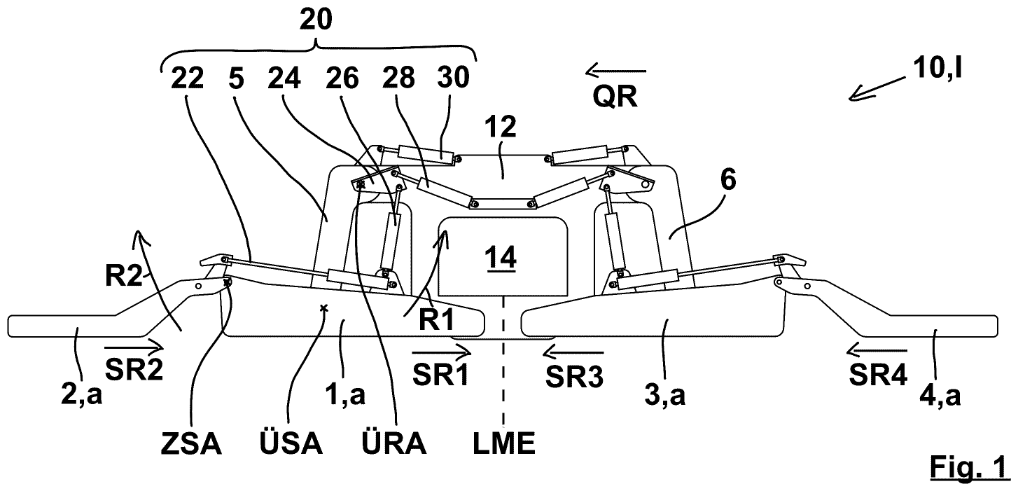

FIG. 1 a front view of a simplified representation of a first inventive header in a working position,

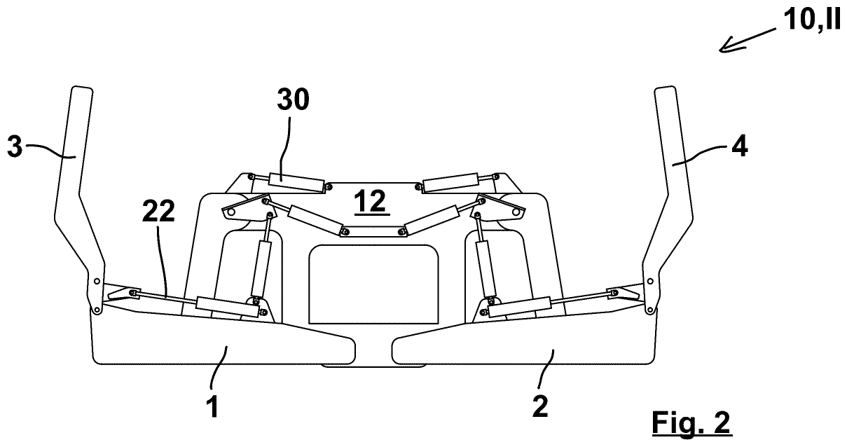

FIG. 2 a front view of the first harvesting header in a first intermediate position,

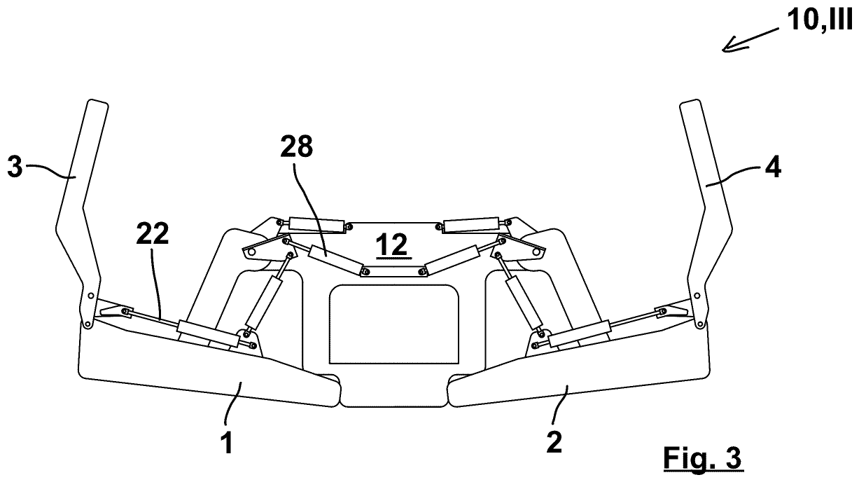

FIG. 3 a front view of the first harvesting header in a second intermediate position,

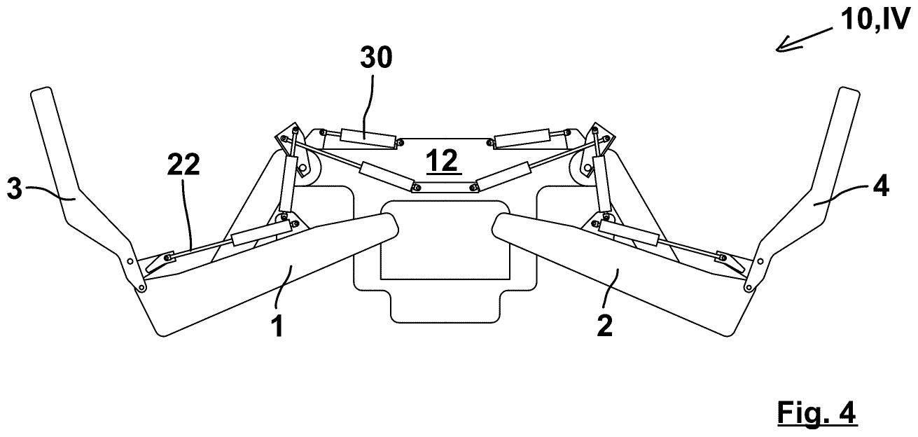

FIG. 4 a front view of the first harvesting header in a third intermediate position,

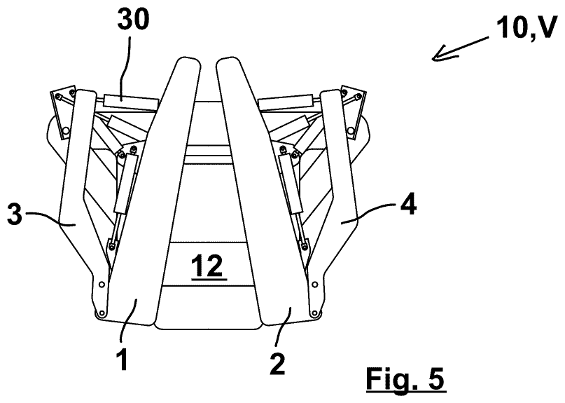

FIG. 5 a front view of the first harvesting header in a fourth intermediate position,

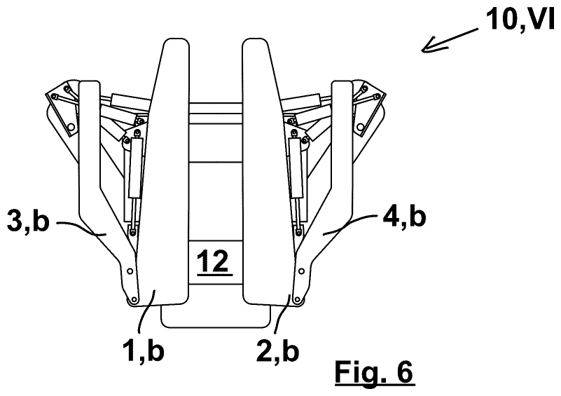

FIG. 6 a front view of the first harvesting header in a transport position,

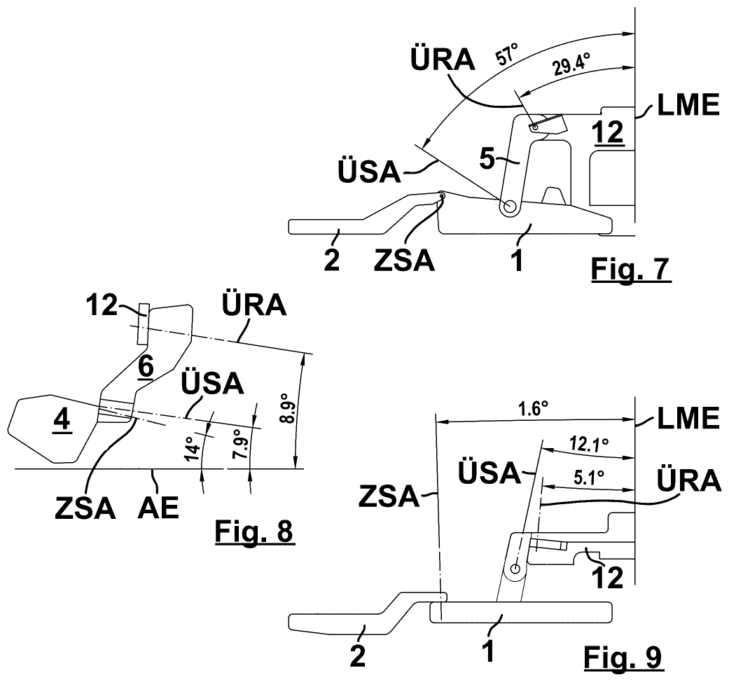

FIG. 7 a further simplified front view of the first harvesting header in the working position,

FIG. 8 a side view of the first harvesting header according to FIG. 7,

FIG. 9 a top view of the first harvesting header according to FIG. 7,

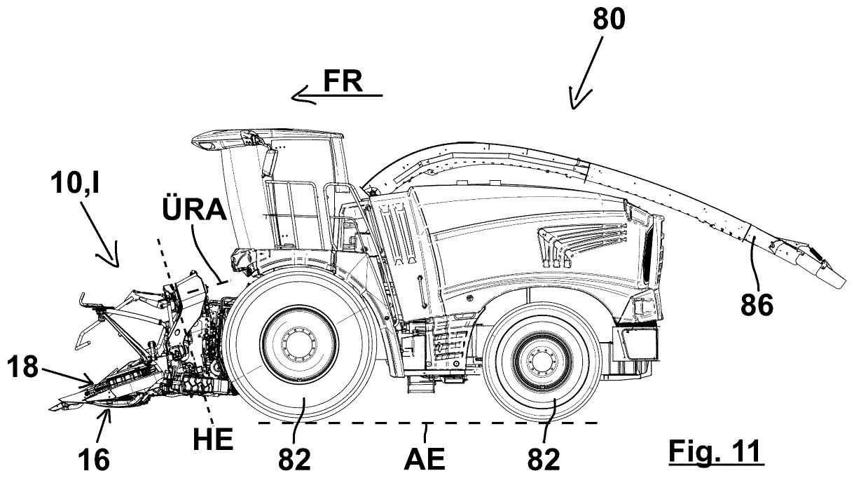

FIG. 11 a side view of a forage harvester with a second harvesting header according to the invention in the working position,

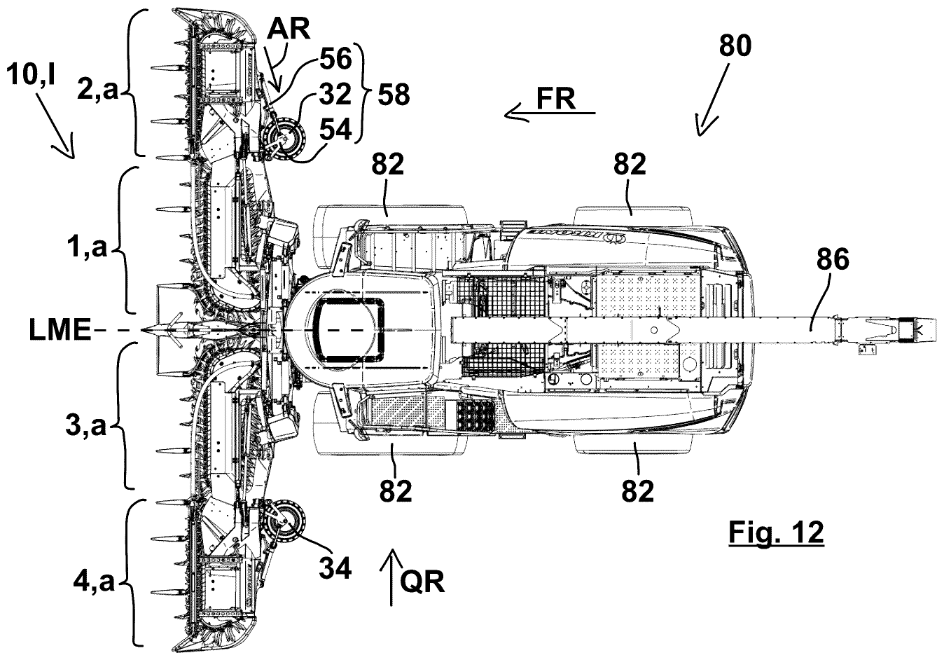

FIG. 12 a top view of the forage harvester with the second harvesting header according to FIG. 11,

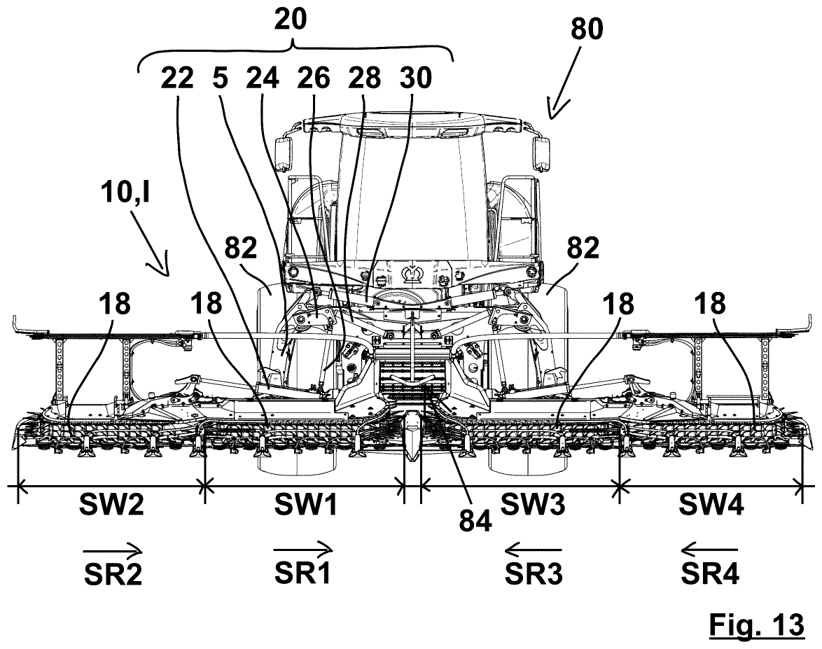

FIG. 13 a front view of the forage harvester and the second harvesting header according to FIG. 11,

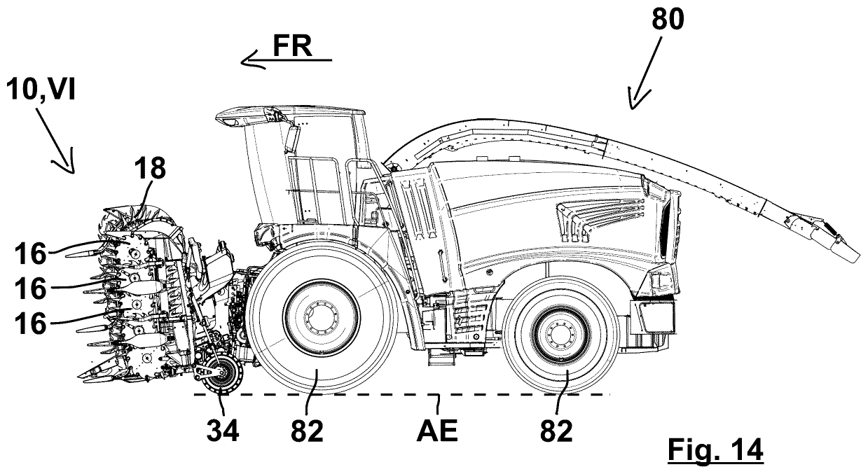

FIG. 14 a side view of the forage harvester and the second harvesting header in a transport position,

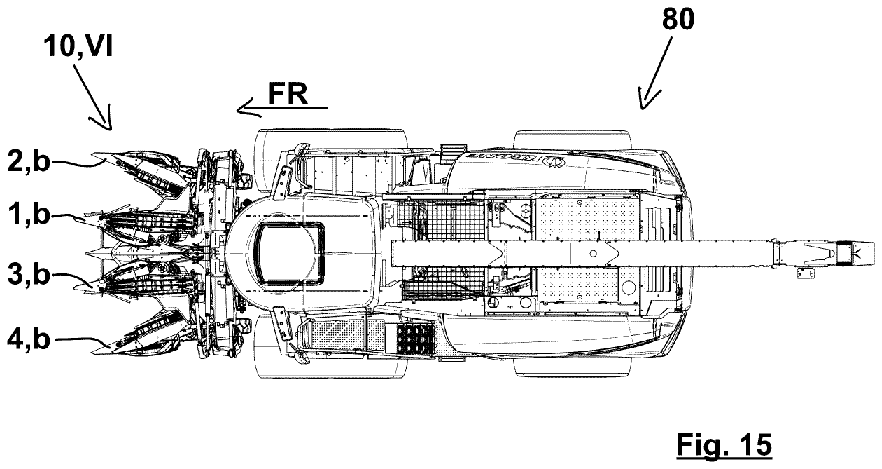

FIG. 15 a top view of the forage harvester and the second harvesting header according to FIG. 14,

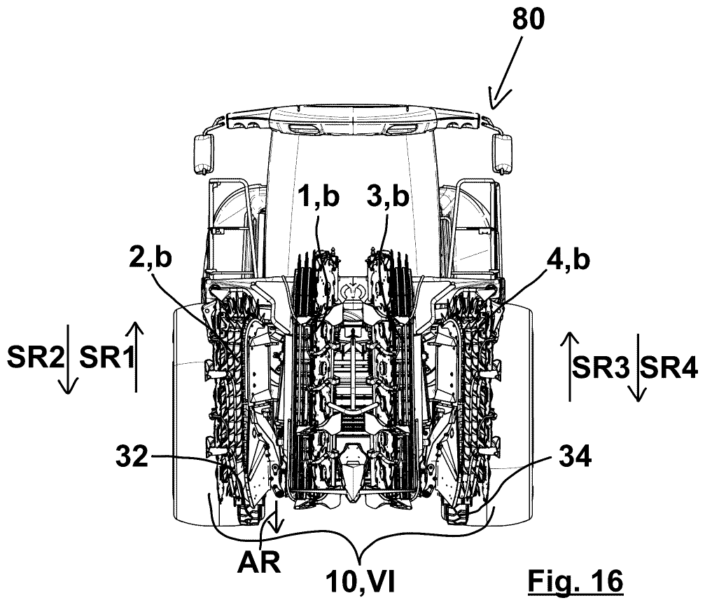

FIG. 16 a front view of the forage harvester and the second harvesting header according to FIG. 14,

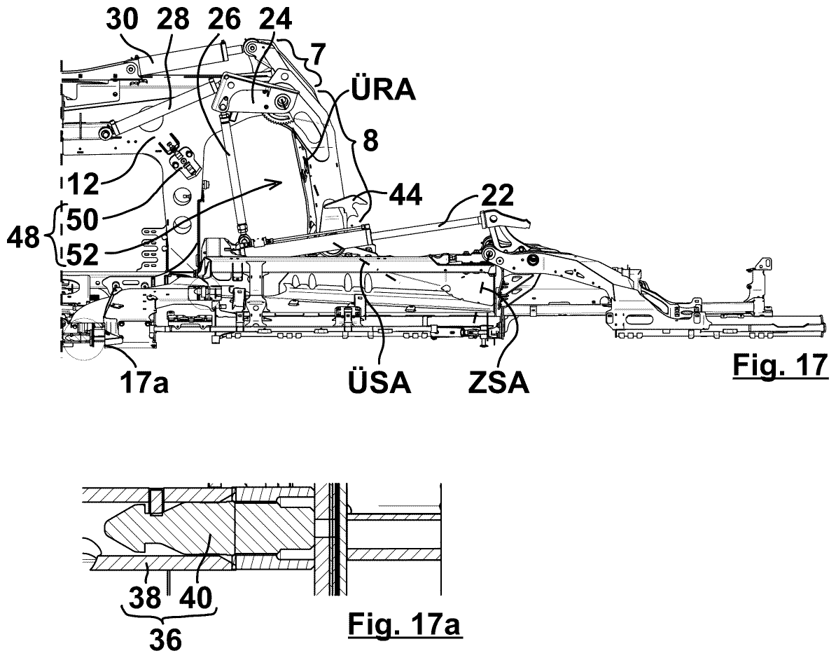

FIG. 17 a front view of the partially illustrated second harvesting header according to FIG. 11,

FIG. 17a an enlarged view of a detail of FIG. 17,

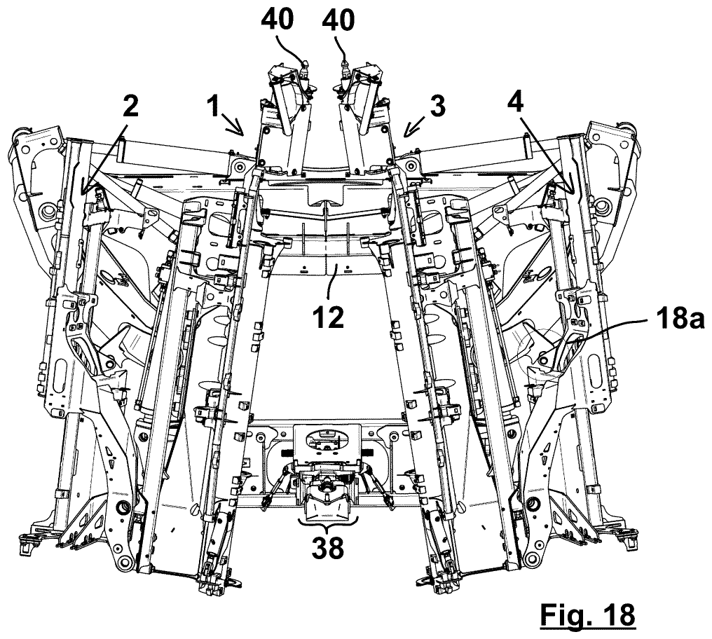

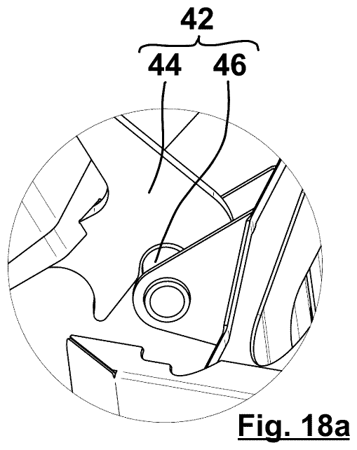

FIG. 18 a front view of the partially illustrated second harvesting header in the fourth intermediate position,

FIG. 18a an enlarged view of a detail of FIG. 18.

Identical or similarly functioning or constructed parts of the inventive embodiments are selectively marked with the same reference numerals in the figures. Features described with respect to one of these parts are to be understood as described with respect to all such parts. Features described with respect to one of two mirror-symmetrically arranged parts are to be understood as described with respect to the other part as well. Inventive developments also arise from other combinations of the described features than those explicitly illustrated.

The figures show various inventive headers 10, each designed for row-independent harvesting of corn. Each header 10 includes a frame structure 12 intended for coupling the respective header 10 to a harvesting vehicle configured as a forage harvester 80. FIGS. 11 through 18a show a second inventive header 10 coupled to the forage harvester 80.

The forage harvester 80 and the header 10 together form a harvesting system configured as a forage harvester system. The forage harvester 80 includes a chassis with four drive elements 82, each adjacent to a ground plane AE. The forage harvester 80 further includes an intake mechanism 84, which—viewed in the direction of travel FR—extends between the front drive elements 82 and subsequently to a feed area 14 of the header 10 (see FIG. 11 ff.). In the direction of crop flow, the intake mechanism 84 is followed by a chopping unit (not shown) and a discharge chute 86 of the forage harvester 80, which is shown in simplified form in the transport position in FIG. 11 ff. During operation, the forage harvester 80 moves forward with the header 10 in the direction of travel FR.

Both the first and second embodiments of the header 10 each include four header segments 1, 2, 3, 4. Each of the header segments 1, 2, 3, 4 includes a plurality of rotating cutting elements 16 for cutting corn plants during operation. Additionally, each of the header segments 1, 2, 3, 4 includes exactly one conveying element 18, configured as a conveyor chain rotating during operation, for conveying the corn plants in a segment-specific conveying direction SR1, SR2, SR3, SR4 (see FIGS. 11 and 14). The first embodiment of the header 10 is simplified in FIGS. 1 through 9 such that the cutting elements 16 and conveying elements 18 are not shown.

Both embodiments of the header 10 include a transfer mechanism 20 for shifting the respective header 10 from a working position I (FIG. 1, 11 to 13) into a transport position VI (FIG. 6, 14 to 16). In the working position, the header segments 1, 2, 3, 4 are arranged side-by-side in a transverse direction QR, which is perpendicular to the direction of travel FR and parallel to the ground plane AE. In the working position I, the header segments 1, 2, 3, 4 are arranged such that their segment conveying directions SR1, SR2, SR3, SR4 are aligned parallel to the transverse direction QR and oriented toward the feed area 14. The header segments 1, 2, 3, 4 are in a first position a in the working position I of the header 10. The feed area 14 is intersected by a longitudinal centreline LME that is perpendicular to the transverse direction QR, and the header 10 is essentially mirror-symmetrical with respect to this centreline. The segment conveying directions SR1 and SR2 are therefore opposite to the segment conveying directions SR3 and SR4. The first header segment 1 and the second header segment 2 extend into the feed area 14 in the working position I.

In the transport position VI, the header segments 1, 2, 3, 4 are arranged such that their segment conveying directions SR1, SR2, SR3, SR4 are all at least substantially aligned parallel to the longitudinal centreline LME. The header segments 1, 2, 3, 4 are in a second position b in the transport position VI of the header 10, in which they are pivoted approximately 90° relative to the frame structure 12 from their first position a. In the transport position VI, the first segment conveying direction SR1 of the first header segment 1 and the third segment conveying direction SR3 of the third header segment 3 are oriented away from the ground plane AE, whereas the second segment conveying direction SR2 of the second header segment 2 and the fourth segment conveying direction SR4 of the fourth header segment 4 are oriented toward the ground plane AE (see FIG. 16). Additionally, in the transport position VI, the second header segment 2 is positioned predominantly ahead of the first transfer element 5 in the direction of travel FR. Similarly, the fourth header segment 4 is positioned predominantly ahead of the second transfer element 6 in the direction of travel FR.

The first header segment 1 is mounted to the frame structure 12 via a first transfer element 5. The third header segment 3 is mounted in mirror symmetry to the frame structure 12 via a second transfer element 6 (see FIG. 1). Both transfer elements 5 and 6 each include an actuator arm 7 and a segment arm 8 (see FIG. 17). The further mirror-symmetrical configuration of the header 10 is described below by way of example for one side only.

The first header segment 1 is pivotably mounted to the first transfer element 5 about a transfer segment pivot axis ÜSA. The first transfer element 5 is pivotably mounted to the frame structure 12 about a transfer frame pivot axis ÜRA. The first transfer element 5 is configured such that one end, extending about the transfer frame pivot axis ÜRA, projects on one side into an auxiliary plane HE perpendicular to the ÜRA (see FIG. 11), while the opposite end, extending about the transfer segment pivot axis ÜSA, also projects into the auxiliary plane. The segment arm 8 spans between the transfer segment pivot axis ÜSA and the transfer frame pivot axis ÜRA. The second header segment 2 is pivotably mounted to the first header segment 1 about an intermediate segment pivot axis ZSA.

To pivot the second header segment 2 about the intermediate segment pivot axis ZSA, the header 10 includes a first actuator 22 positioned between the first and second header segments. In the working position I of the header 10, this actuator is located ahead of the first transfer element 5 in the direction of travel FR. To pivot the first header segment 1 about the transfer segment pivot axis ÜSA, the header 10 includes a second actuator 28 positioned between the frame structure 12 and a pivotable transmission element 24, which rotates about the transfer frame pivot axis ÜRA. A double-pivoted link 26 is arranged between the transmission element 24 and the first header segment 1. To pivot the first transfer element 5 about the transfer frame pivot axis URA, the header 10 includes a third actuator 30 positioned between the frame structure 12 and the first transfer element 5. The actuator arm 7 spans between the third actuator 30 and the transfer frame pivot axis URA. The second and third actuators 28, 30 are positioned above the first header segment 1 in the working position I. The header 10 is mirror-symmetrical with respect to the longitudinal centreline LME in terms of header segments 1-4, transfer elements 5, 6, actuators 22, 28, 30, transmission elements 24, links 26, and the frame structure 12.

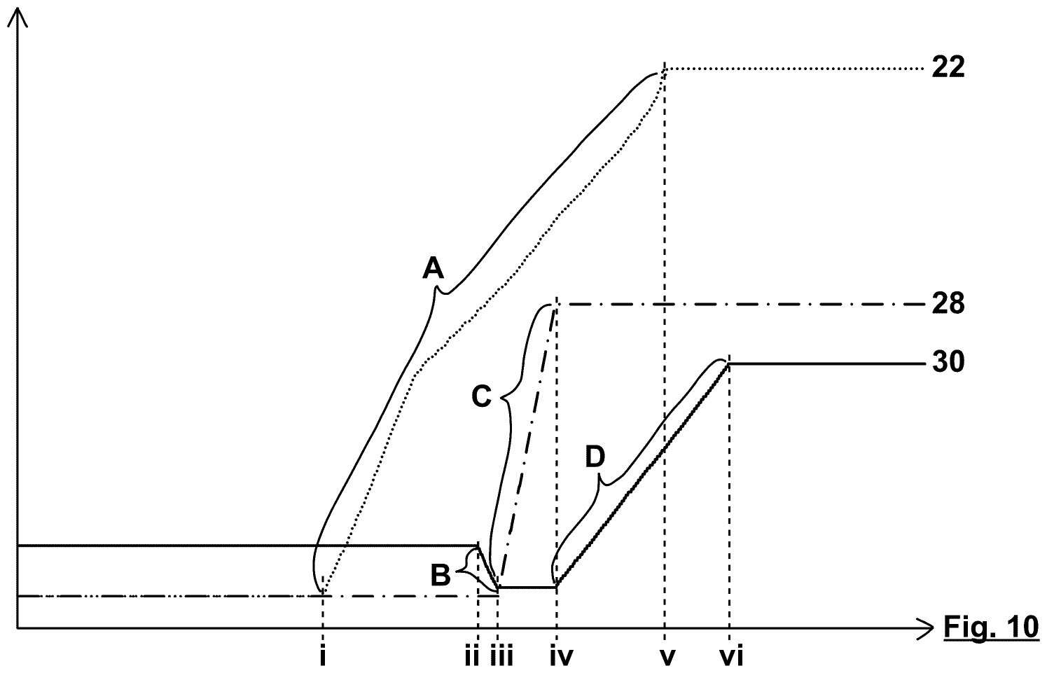

Using actuators 22, 28, and 30, the header 10 can be shifted from the working position I into the transport position VI. During this transfer, the header 10 passes through four intermediate positions II to V, illustrated in FIGS. 2 to 5. The function of actuators 22, 28, and 30 during the transfer process is shown in the diagram in FIG. 10.

According to the transfer method of the invention, a first pivoting A of the second header segment 2 relative to the first header segment 1 begins (timepoint i) before a further pivoting C, D of the first header segment 1 relative to the frame structure 12 begins in a first pivot direction R1 (timepoint iii). The first pivoting A occurs in a second pivot direction R2, opposite to the first pivot direction R1. In the front views shown in FIGS. 1 to 6, the second pivot direction R2 corresponds to clockwise rotation, and the first pivot direction R1 corresponds to counterclockwise rotation.

A second pivoting B of the first header segment 1 relative to the frame structure 12 in the second pivot direction R2 begins and ends (timepoints ii, iii) before the further pivoting C, D. The second pivoting B includes pivoting the transfer element 5 relative to the frame structure 12 about the transfer frame pivot axis URA. The second pivoting B begins during the first pivoting A (timepoint ii).

The first pivoting A ends (timepoint v) before the further pivoting C, D ends (timepoint vi). The further pivoting C, D includes a third pivoting C and a fourth pivoting D. In the third pivoting C, the first header segment 1 is pivoted relative to the transfer element 5 about the transfer segment pivot axis USA. In the fourth pivoting D, the transfer element 5 is pivoted relative to the frame structure 12 about the transfer frame pivot axis ÜRA. The third pivoting C begins and ends (timepoints iii, iv) before or during the start of the fourth pivoting D (timepoint iv). The second pivoting B and the third pivoting C end before the first pivoting A ends (timepoint v). The fourth pivoting D begins (timepoint iv) before the first pivoting A ends (timepoint v).

FIGS. 7 to 9 show various views of one half of the first header 10 as depicted in FIGS. 1 to 6, with further simplification. These figures include angular references illustrating the positions of the transfer frame pivot axis URA, the transfer segment pivot axis USA, and the intermediate segment pivot axis ZSA.

FIGS. 11 to 16 illustrate support wheels 32, 34. A first support wheel 32 is mounted to the second header segment 2. It is positioned such that its rotational axis is aligned parallel to the ground plane AE in the transport position VI. In the working position I, the rotational axis is angled relative to the ground plane AE by the same angle as the segment conveying direction SR2 of the second header segment 2 in the transport position VI. The second support wheel 34 is mounted in mirror symmetry to the first support wheel 32 on the fourth header segment 4.

FIG. 13 illustrates the conveying elements 18 of header segments 1-4 in the working position I of the header 10. Each header segment 18 is configured to convey corn plants along a segment-specific conveying path SW1, SW2, SW3, SW4. In the illustrated embodiment, conveying paths SW1 and SW3 are longer than SW2 and SW4. In inventive headers 10 with greater working widths than those shown, conveying paths SW2 and SW4 are preferably longer than SW1 and SW3.

FIG. 12 illustrates two support wheels 32, 34. One of the support wheels 32 is part of a support wheel assembly 58, which also includes a support wheel actuator 56 that is length-adjustable within a wheel actuator housing AR. The assembly further includes a wheel link element 54, pivotably mounted to the second header segment 2. The second support wheel 34 is similarly and symmetrically mounted to the fourth header segment 4 in a manner that is identical and mirror-symmetrical to the first support wheel 32.

FIGS. 17 and 18 show the second header 10 partially in the working position I, with cutting and conveying elements omitted to better illustrate the components described below. FIG. 17 is a front view of one half of the second header 10. It illustrates a frame transfer locking device 48 for securing the second transfer element 6 to the frame structure 12 when the header is in the transport position VI. The locking device 48 includes a first locking partner 50 on the frame structure 12 and a second locking partner 52 on the second transfer element 6. These are spaced apart in the working position I and engaged in the transport position VI.

Reference numeral 17a in FIG. 17 marks a region shown enlarged in FIG. 17a. This region shows a frame segment locking device 36 for securing the third header segment 3 to the frame structure 12 when the header is in the working position. The locking device 36 includes a first locking partner 38 on the frame structure 12, a second locking partner 40 on the third header segment 3, and an additional second locking partner 40 on the first header segment 1 (see FIG. 18). The first locking partner 38 is formed as a recess open opposite the transverse direction QR. The second locking partner 40 is formed as a pin extending in the transverse direction QR.

FIG. 18 shows the second header 10 partially in the fourth intermediate position. Reference numeral 18a in FIG. 18 marks a region shown enlarged in FIG. 18a. This region shows a transfer segment locking device 42 for securing the fourth header segment 4 to the second transfer element 6 when the header is in the transport position VI. The locking device 42 includes a first locking partner 44 on the second transfer element 6 (see also FIG. 17) and a second locking partner 46 on the fourth header segment 4. The first locking partner 44 is formed as a hook, and the second locking partner 46 is formed as a bolt designed to engage with the hook.

### LIST OF REFERENCES

1 First header segment
2 Second header segment
3 Third header segment
4 Fourth header segment
5 First transfer element
6 Second transfer element
7 Actuator arm
8 Segment arm
10 Harvesting header
12 Frame structure
14 Feed area
16 Cutting element
18 Conveyor element
20 Transfer mechanism
22 First actuator
26 Link element
28 Second actuator
30 Third actuator
32 First support wheel
34 Second support wheel
36 Frame segment locking device
38 First locking partner
40 Second locking partner
42 Transfer segment locking device
44 First locking partner
46 Second locking partner
48 Frame transfer locking device
50 First locking partner
52 Second locking partner
54 Wheel link element
56 Support wheel actuator
58 Support wheel assembly
80 Harvesting vehicle
82 Drive element
84 Feed mechanism
86 Discharge chute
i Start of first pivoting
ii Start of second pivoting
iii Start of third pivoting/End of second pivoting
iv Start of fourth pivoting/End of third pivoting
v End of first pivoting
vi End of fourth pivoting
I Working position
II First intermediate position
III Second intermediate position
IV Third intermediate position
V Fourth intermediate position
VI Transport position
a First position
b Second position
A First pivoting
B Second pivoting
C Third pivoting
D Fourth pivoting
AE Ground plane
AR Wheel actuator housing
FR Direction of travel
HE Auxiliary level
LME Longitudinal centreline
QR Transverse direction
R1 First pivot direction
R2 Second pivot direction
SR1 Segment conveying direction of first header segment
SR2 Segment conveying direction of second header segment
SR3 Segment conveying direction of third header segment
SR4 Segment feed direction of fourth header segment
SW1 Segment feed path of first header segment
SW2 Segment conveyor path of second header segment
SW3 Segment conveyor path of third header segment
SW4 Segment conveyor path of fourth header segment
ÜRA Transfer frame pivot axis
ÜSA Transfer segment pivot axis
ZSA Intermediate segment pivot axis

1. A header (10) for row-independent harvesting of corn, comprising:
a frame structure (12) designed for coupling to a forage harvester (80),
at least three header segments (1, 2, 3, 4), each comprising:
at least one cutting element (16) rotating during operation for cutting corn plants, and
at least one conveying element (18) rotating during operation for conveying the corn plants in a segment-specific conveying direction (SR1, SR2, SR3, SR4), and
a transfer mechanism (20) for shifting the header (10) from a working position (I),
in which the header segments (1, 2, 3, 4) are connected to one another in a transverse direction (QR) perpendicular to the direction of travel (FR) such that their segment conveying directions (SR1, SR2, SR3, SR4) are aligned parallel to a ground plane (AE) and oriented toward a feed area (14) intersected by a longitudinal centreline (LME) perpendicular to the transverse direction (QR), from which feed area (14) the corn plants are drawn in by the forage harvester (80), at least partially, against the direction of travel (FR), into a transport position (VI),
in which at least one of the header segments (1, 2, 3, 4) is arranged in such a way that its segment conveying direction (SR1, SR2, SR3, SR4) is aligned at an angle to the ground plane (AE),
wherein the at least three header segments (1, 2, 3, 4) comprise at least one first header segment (1) which, in the working position (I), extends into or through the feed area (14),
characterized by a design of the transfer mechanism (20) for transferring the header (10) such that the segment conveying direction (SR1) of the first header segment (1) is aligned at an angle to the ground plane (AE) in the transport position (VI) of the header (10).

2. The header according to claim 1, characterized by a design of the transfer mechanism (20) such that the segment conveying direction (SR1) of the first header segment (1) is aligned at an angle of at least 60° relative to the ground plane (AE) in the transport position (VI), in particular is aligned parallel to the longitudinal centreline (LME).

3. The header according to claim 1, characterized by a design of the transfer mechanism (20) such that the segment conveying direction (SR1) of the first header segment (1) is oriented away from the ground plane (AE) in the transport position (VI).

4. The header according to claim 1, characterized by a design of the transfer mechanism (20) for transferring the header (10) such that the segment conveying directions (SR1, SR2, SR3, SR4) of all header segments (1, 2, 3, 4) are aligned at an angle, preferably by at least 60°, relative to the ground plane (AE) in the transport position (VI), and more preferably aligned parallel to the longitudinal centreline (LME).

5. The header according to claim 1, characterized in that each header segment (1, 2, 3, 4) includes a conveying element (18) designed as a conveyor chain and two rotatably mounted deflection elements around which the conveying element (18) circulates during operation.

6. The header according to claim 1, characterized by at least four, in particular exactly four, header segments (1, 2, 3, 4) and/or a mirror-symmetrical design relative to the longitudinal centreline (LME).

7. The header according to claim 1, characterized in that a conveying element (18) of the first header segment (1) is configured to convey corn plants in its segment conveying direction (SR1) along a first segment conveying path (SW1), and a conveying element (18) of a second header segment (2), which in the working position (I) of the header (10), adjoins a side of the first header segment (1) facing away from the longitudinal centreline (LME), is configured to convey corn plants in its segment conveying direction (SR2) along a second segment conveying path (SW2), which is longer than the first segment conveying path (SW1).

8. The header according to claim 1, characterized in that the first header segment (1) is pivotably mounted about a transfer segment pivot axis (USA) to a transfer element (5), which is itself pivotably mounted about a transfer frame pivot axis (URA) to the frame structure (12), and/or the second header segment (2) is pivotably mounted on an intermediate segment pivot axis (ZSA) to the first header segment (1).

9. A transfer method for shifting the header (10) according to claim 1 from the working position (I) into the transport position (VI), wherein a first pivoting (A) of the second header segment (2) relative to the first header segment (1) begins (i) before a further pivoting (C, D) of the first header segment (1) relative to the frame structure (12) in a first pivot direction (R1) begins (ii).

10. The transfer method according to claim 9, characterized in that the first pivoting (A) occurs in a second pivot direction (R2) opposite to the first pivot direction (R1).

11. The transfer method according to claim 9, characterized by a second pivoting (B) of the first header segment (1) relative to the frame structure (12) in the second pivot direction (R2), wherein the second pivoting (B) begins (ii), and preferably ends (iii), before the further pivoting (C, D).

12. The transfer method according to claim 9, characterized in that the second pivoting (B) includes pivoting the transfer element (5) relative to the frame structure (12) about the transfer frame pivot axis (URA).

13. The transfer method according to claim 9, characterized in that the second pivoting (B) begins during the first pivoting (A) (ii).

14. The transfer method according to claim 9, characterized in that the first pivoting (A) ends (v) before or during the end of the further pivoting (C, D) (iv).

15. The transfer method according to claim 9, characterized in that the further pivoting (C, D) includes a third pivoting (C) of the first header segment (1) relative to the transfer element (5) about the transfer segment pivot axis (USA), and a fourth pivoting (D) of the transfer element (5) relative to the frame structure (12) about the transfer frame pivot axis (ORA).

16. The transfer method according to claim 9, characterized in that the third pivoting (C) begins (iii), and in particular ends (iv), before or during the start of the fourth pivoting (D) (iv).

17. Transfer method according to claim 9, characterized in that the second pivoting (B), the third pivoting (C), and/or the fourth pivoting (D) begin (ii, iii, iv), and in particular end (iii, iv, vi), before the first pivoting (A) ends (v).

18. A forage harvester system comprising a forage harvester (80) having a chassis with multiple drive elements (82) adjacent to the ground plane (AE), an intake mechanism (84), a chopping unit, and a discharge chute (86), and a header (10) according to claim 1, which is coupled to the forage harvester (80) via the frame structure (12) such that the intake mechanism (84) draws in corn plants from the feed area (14) at least partially against the direction of travel (FR) during operation.

19. The forage harvester system according to claim 18, characterized by a design for carrying out the transfer method according to claim 9.
